(19) United States
(12) Patent Application Publication
(10) Pub. No.: US 2012/0211297 A1
(43) Pub. Date: Aug. 23, 2012

(54) HOOD PEDESTRIAN ENERGY ABSORBER

(76) Inventors: Daniel D. Ralston, Walker, MI (US); Vidya Revankar, Rochester Hills, MI (US); David R. Seiter, Brighton, MI (US); Amit Kulkarni, Grand Haven, MI (US)

(21) Appl. No.: 13/409,694

(22) Filed: Mar. 1, 2012

Related U.S. Application Data
(63) Continuation-in-part of application No. 13/040,747, filed on Mar. 4, 2011.
(60) Provisional application No. 61/310,883, filed on Mar. 5, 2010.
(60) Provisional application No. 61/448,841, filed on Mar. 3, 2011.

(51) Int. Cl. B60R 21/34

(52) U.S. Cl. 180/274

(57) ABSTRACT

An energy absorbing system includes a hood with inner and outer panels defining a rear edge cavity, and a pair of polymeric energy absorbers in the cavity. The hood and energy absorber are tuned to minimize an HIC value when a pedestrian's head contacts the hood during an impact to absorb energy prior to the hood bottoming out on the plenum of the vehicle. The energy absorber is preferably made of a polymeric material capable of withstanding high temperatures associated with going through a paint oven or e-coat process, such as high temperature nylon. The illustrated energy absorber has a hat-shaped cross section and includes criss-crossing flanges tuned to provide an optimal force-deflection curve during impact.

### CROSS-REFERENCE TO RELATED APPLICATION

This application is a continuation-in-part under 35 U.S.C. §120 of U.S. Application No. 13/040,747, filed Mar. 4, 2011, entitled HOOD PEDESTRIAN ENERGY ABSORBER, which claims benefit under 35 USC §119(e) of provisional application Ser. No. 61/310,883, filed Mar. 5, 2010, entitled HOOD PEDESTRIAN ENERGY ABSORBER; and claims benefit under 35 USC §119(e) of provisional application Ser. No. 61/448,841, filed Mar. 3, 2011, entitled UNDERHOOD COVERS DESIGNED WITH ENERGY ABSORBING CRUSH LOBES the entire contents of which are incorporated herein by reference.

### BACKGROUND

The present invention relates to vehicle hoods, and more particularly relates to a hood assembly incorporating a crushable energy absorber to provide improved pedestrian safety against a vehicle impact.

In an attempt to prevent or minimize pedestrian injury during an impact with an automobile, it is desired that a pedestrian's head incur a reduced head impact criteria (HIC) value during the impact. In fact, there is a Global Technical Regulation (GTR) for pedestrian impacts that is in the process of being adopted. Additionally, the European and Japanese New Care Assessment Program (Euro NCAP) also evaluates vehicles in this regard.

However, any change for improved pedestrian safety during impact must also not adversely affect overall performance of a hood (i.e. “hood assembly”), nor aesthetics of the hood, including a time during normal operation of the vehicle, and also during a vehicle front end impact where the hood must satisfy occupant safety requirements. Thus, there are conflicting requirements on how to meet any such HIC value or GTR requirement. The present invention relates to covers and baffles in an engine compartment constructed with an additional function of absorbing energy upon pedestrian impact.

A Pedestrian often receives a head injury when impacted by a vehicle, such as when a pedestrian's body falls onto and strikes the vehicle's hood during the accident. Improvements are desired to reduce pedestrian head injuries, but there are conflicting requirements. For example, vehicle manufacturers do not want to add components or expense, nor make components more complex or difficult to assemble. Further, vehicle manufacturers do not want to add unnecessary weight, nor unnecessarily limit vehicle aesthetics. Still further, any change should accommodate existing technologies.

### SUMMARY OF THE PRESENT INVENTION

In one aspect of the present invention, a vehicle includes a front end having underhood hard structural components defining an engine compartment, an engine component, and a hood generally covering the engine compartment. An energy-absorbing improvement includes a top cover under the hood and covering a part of at least one of the hard structural components and the engine component, the cover including at least one vertically-extending energy-absorbing feature configured specifically to absorb energy during a top-down impact from a pedestrian's head during a vehicle collision with the pedestrian, the feature being located under the hood and above the one component at a location to support the hood and cushion the impact against the head.

In another aspect of the present invention, a combination includes a vehicle front end having underhood hard structural components defining an engine compartment, an engine component, and a hood assembly generally covering the engine compartment, the hood assembly including a hood outer panel and a hood inner panel. An improvement includes an energy absorber positioned between the hood outer panel and a selected one of the underhood hard structural components. The energy absorber includes a base flange and a plurality of hollow crush lobes extending from the base flange in a direction generally perpendicular to an adjacent portion of the hood outer panel.

In another aspect of the present invention, a method includes providing a vehicle front end having underhood hard structural components defining an engine compartment, an engine component, and a hood assembly generally covering the engine compartment, the hood assembly including a hood outer panel and a hood inner panel; and providing an energy absorber including a base flange and a plurality of hollow crush lobes extending from the base flange. The method further includes positioning the energy absorber between the hood outer panel and a selected one of the underhood hard structural components with the crush lobe of the energy absorber extending in a direction generally perpendicular and upwardly relative to an adjacent portion of the hood outer panel. These and other aspects, objects, and features of the present invention will be understood and appreciated by those skilled in the art upon studying the following specification, claims, and appended drawings.

### BRIEF DESCRIPTION OF DRAWINGS

FIG. 1 is a top view of a vehicle front end, including a portion of a rear of the engine hood and a portion of the vehicle front windshield.

FIG. 2 is a side view of FIG. 1 taken along a longitudinal line of the vehicle, including a pedestrian's head shown in dashed lines.

FIGS. 3-9 are perspective views of different hood energy absorbers for optimizing HIC for pedestrian-vehicle impacts.

FIGS. 10-11 are top and perspective views of a hood and showing multiple locations of energy absorbers and also additional energy absorbers for use in the hood.

FIG. 12 is a side view of a vehicle front end, including two differently positioned impactors for simulating a pedestrian's head impact against the vehicle during an accident.

FIG. 13 is a perspective view of a component cover including energy-absorbing features (channel ridges) for energy absorption, and FIG. 13A is a modified cover including crush lobes.

FIG. 14 is a perspective view of the front end of FIG. 13, the hood outer panel being removed to better show under-hood hard structural components under the hood and also to show the cover of FIG. 13 having energy-absorbing features thereon.

FIG. 15 is a perspective view of a vehicle engineer compartment including a fuse box, a fuse box cover, a battery, and a battery cover, with the covers including vertically-extending crush lobes.

FIGS. 16 and 17 are perspective views of the fuse box cover and battery cover in FIG. 15.

### DETAILED DESCRIPTION OF PREFERRED EMBODIMENTS

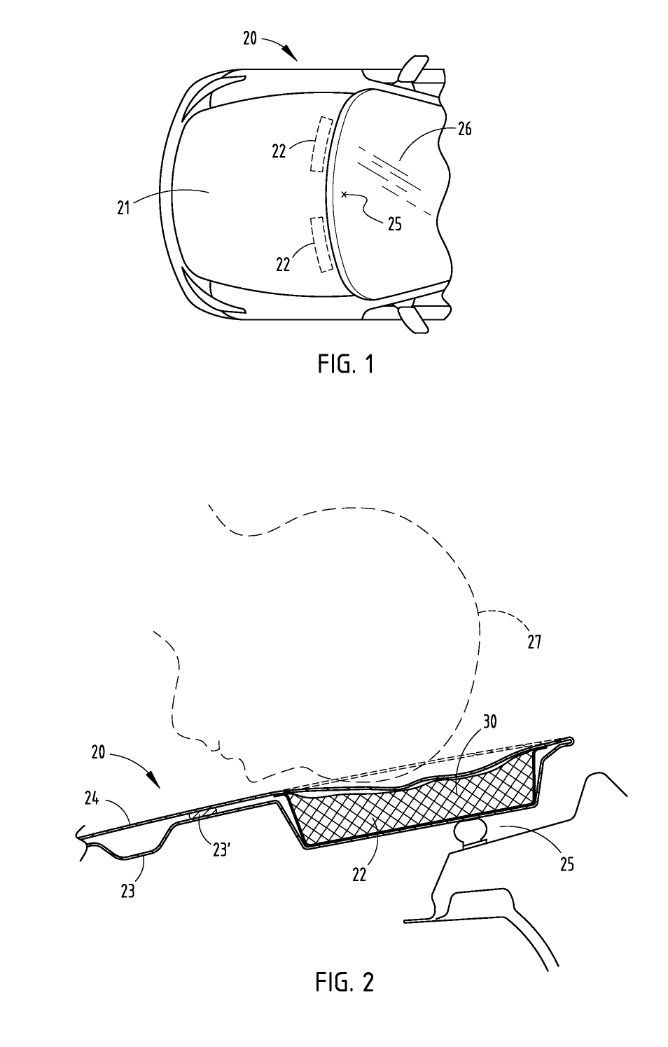

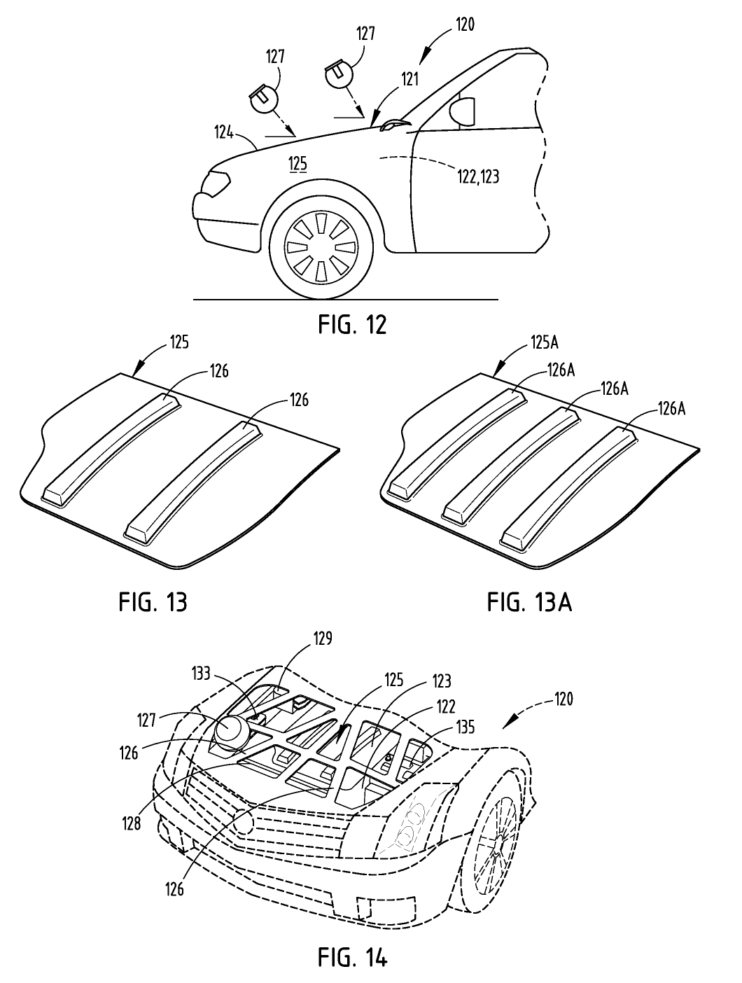

The present invention focuses on energy absorbers positioned under an outer (top) panel of a vehicle's hood and above structural components under the hood. In one form (FIGS. 1-11), the energy absorber is attached to the hood assembly, and in another form (FIGS. 12-17), the energy absorber attached to structural components under the hood (and is not directly attached to the hood assembly).

The present apparatus 20 (FIGS. 1-3) includes a vehicle hood 21 with energy absorber 22 positioned in a cavity 30 between the hood's inner and outer panels 23 and 24 near the plenum 25 of the vehicle (i.e., immediately in front of the vehicle's front windshield 26). The panels 23 and 24 are commonly held together using mastic adhesive 23′ and/or by mechanical means (such as by hemmed flanges along a perimeter of the hood), with the inner panel 23 stiffening the outer panel 24 for aesthetics and function. During a pedestrian impact, a pedestrian's head 27 may engage the hood 21 near a rear of the hood as the pedestrian falls/tumbles onto the hood. The force and stroke of the impact are related to the extent of injury caused. By limiting maximum force spikes and providing optimal resistance levels over the stroke distance and time period of impact, the amount of injury can be reduced.

As shown in FIG. 2, the illustrated inner and outer panels 23 and 24 define right and left cavities 30 near a rear of the hood 21. The energy absorber 22 is configured to fit into the cavity 30 and to engage the hood inner and outer panels 23-24 as it is crushed during a top-down impact from a pedestrian's head during a vehicle-pedestrian impact. Notably, a cross-sectional shape of the illustrated energy absorber 22 generally matches a cross-sectional shape of the cavity 30, such that top, bottom, and sides of the energy absorber 22 engage adjacent surfaces and structure forming the cavity 30. Potentially, an outer perimeter flange of the energy absorber 22 is positioned partially within a wedge-shaped edge of the cavity 30, such as is shown near the hood outer 24 in FIG. 2. Sidewalls of the energy absorber 22 extend at an angle between the hood inner and outer 23, 24, such as at an angle of 45 degrees to 90 degrees to the hood outer 24. The energy absorber 22, and in particular the sidewalls are positioned such that they crumple and bend at one or more locations in a manner maximizing energy absorption during the impact while minimizing load spikes and peaks, and while also minimizing HIC values. The energy absorber 22 can be made from different materials. A preferred material is nylon (or other heat resistant polymer), which is an injection molded non-foam polymer such that the side walls have a solid mass.

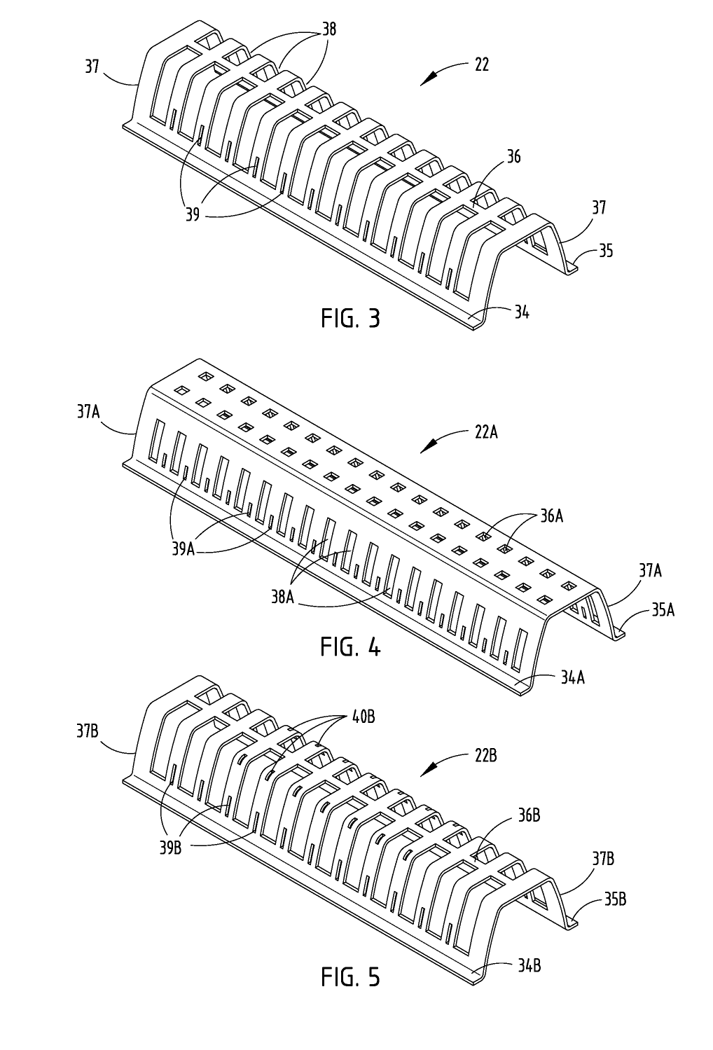

It is contemplated that the energy absorbers can be customized to have different structures and can be made of different materials to provide different functions, characteristics, and aesthetic appearances in the assembled hood. For example, the energy absorber 22 (FIG. 3) includes longitudinal edge flanges 34 and 35, a longitudinal middle flange 36, and transverse U-shaped “bridge” flanges 37 and 38. It is noted that the end-located flanges 37 can be made slightly larger than the other bridge flanges 38, and further that particular flanges 34-38 can be tuned to a provide a particular energy-absorbing profile and function. For example, the flanges 38 located away from the ends have an aperture 39 near their ends. In cross section, the energy absorber defines a hat shaped profile, with relatively flat top section matching the hood outer panel, relatively curved side sections matching a changing shape of the cavity between the inner and outer panels, and a relatively outwardly-extending flat edge flanges matching a narrow feature where the inner and outer panels join.

Energy absorber 22A (FIG. 4) includes edge flanges 34A-35A and three middle flanges 36A and almost double the number of bridge flanges 37A-38A. Also, the end flanges 37A are considerably smaller in width than the earlier end flange 37, and the end flanges 37A are similar in width to the middle flanges 38A. Also, flanges 38A include apertures 39A.

Energy absorber 22B (FIG. 5) is similar to energy absorber 22 in terms of the cross-sectional size and spacing and size of flanges 34B-38B. However, some flanges 38B have additional apertures 40B near an upper bend leading onto their top surface. These apertures 40B reduce an impact strength of the energy absorber 22B near a center area of the energy absorber 22B.

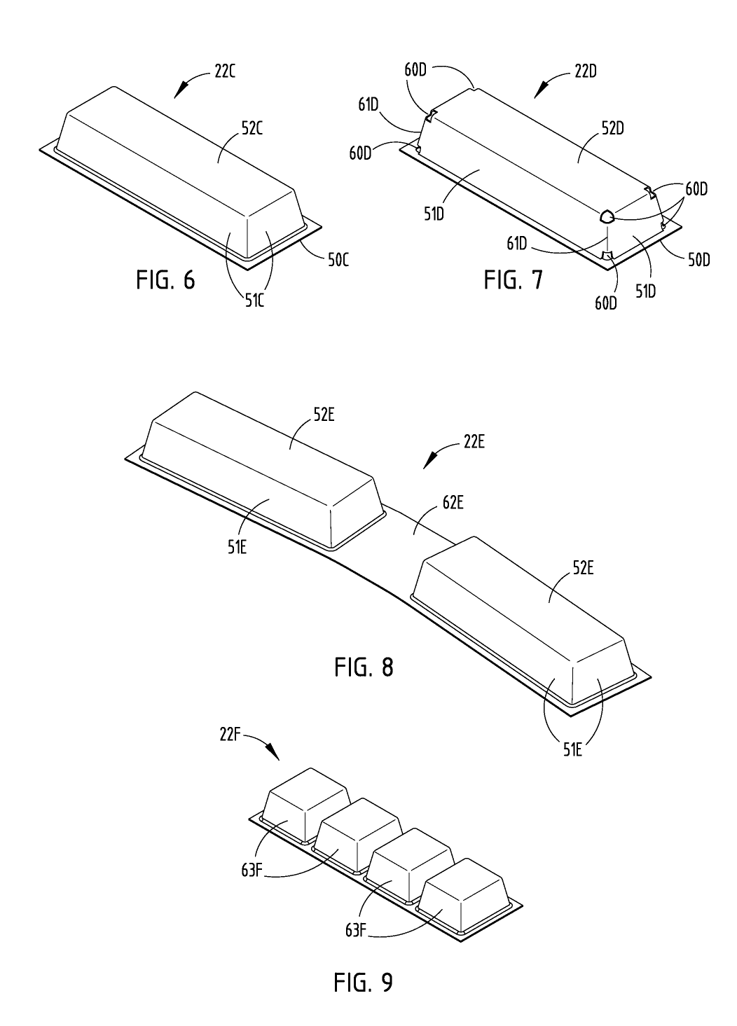

Energy absorbers 22C-22H (FIGS. 6-11) are similar to energy absorbers 22-22B in terms of their outer shape and profile, but the energy absorbers 22C-22H include side walls with less openings such that they have more mass and have the ability to absorb more energy (depending on a thickness and shape of the walls, as noted below). Specifically, energy absorber 22C (FIG. 6) includes a base (top) flange 50C, side walls 51C, and bottom wall 52C, with the walls 51C and 52C forming a crush box where the walls 51C crumple and collapse during an impact with multiple bends and folds for optimal energy absorption during the impact, while minimizing load spikes and peaks. Energy absorber 22D (FIG. 7) is similar to the energy absorber 22C (FIG. 6), and similar components are similarly identified except using a letter D. However, energy absorber 22D includes apertures 60D at top and bottom of corners 61D (i.e. at locations of juncture of the side walls 51D). The reason for apertures 60D is because with zero apertures, the corners 61D have increased beam strength over the side wall 51D itself, thus potentially leading to load spikes during an impact (depending on where a pedestrian's head strikes the hood). By providing apertures 60D, the beam strength is reduced, such that the entire crush box provides a more uniform expected impact strength regardless of the impact location. The energy absorber 22E (FIG. 8) is similar to energy absorber 22C (FIG. 6), except that the right and left components form right and left parts that are connected by a strap 62E, such that energy absorber 22E is molded as a single component that can be handled and assembled into the hood as a single unit. The energy absorber 22F (FIG. 9) is similar to energy absorber 22C, except that energy absorber 22F has four adjacent (smaller) crush boxes 63F formed in a same space as the single crush box of energy absorber 22C.

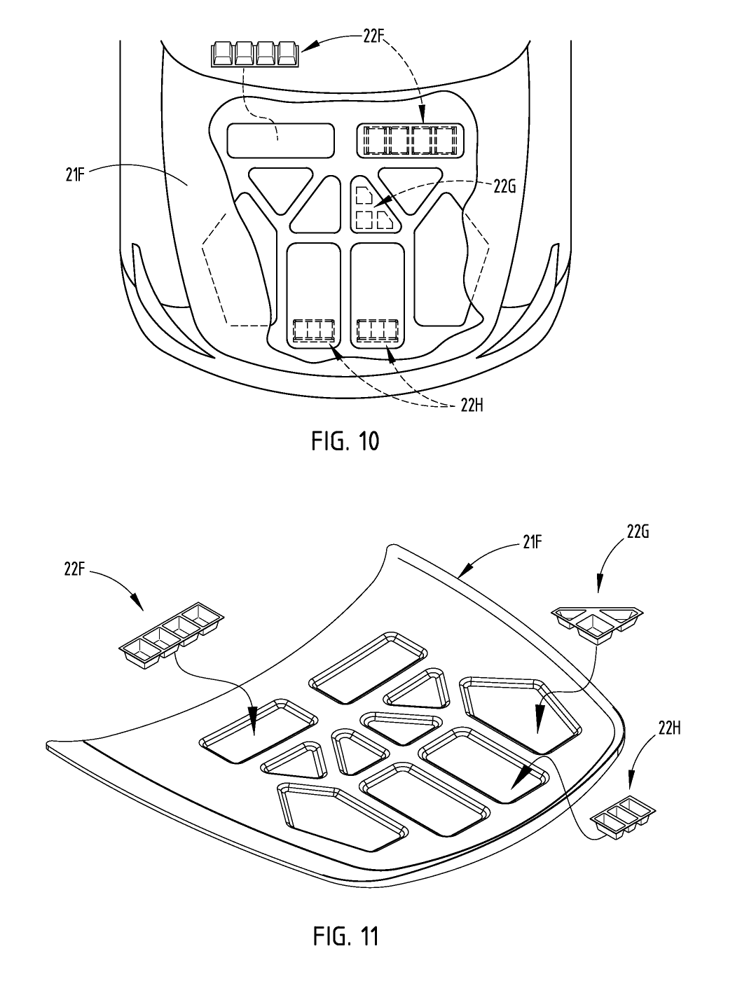

FIGS. 10-11 show a hood 21F having multiple energy absorbers 22F, 22G, and 22H generally located under the hood outer panel in an opening in the hood inner panel. For example, the energy absorber 22F is located along a rear edge of the hood 21F (near a vehicle's plenum area, but in an opening near a rear of the hood inner panel), and with the energy absorber 22G located partially in a downwardly-open triangular cavity defined by the hood inner panel under the hood outer panel (such as over the engine or other hard under-hood structures), and with the energy absorber 22H positioned at a front of the hood 21F in an opening in the hood inner panel (such as near a hood latch or over the vehicle's bulkhead structure supporting a radiator). Flanges on a perimeter of the energy absorbers 22F, 22G and 22H keep the energy absorbers attached to the hood assembly. Of course, it is contemplated that any of the energy absorbers could also be entirely within a cavity between the hood inner and outer panels.

The illustrated energy absorbers 22 are each about 35-40 mm tall, about 92 mm wide and about 365 mm long. The energy absorbers 22A-22J are similarly sized as necessary to fit within the cavity they are intended for. As illustrated, the hood 21 creates right and left cavities, but it is contemplated that a single cross-car cavity can exist and that a single energy absorber could extend completely cross car. Alternatively, it is contemplated that the illustrated two energy absorbers can be interconnected by a strap or tether or other connector so that they can be handled as a unit. The illustrated energy absorbers have a cross-sectional shape formed by slightly angled walls that are open and generally not orthogonal. It is contemplated that a cross sectional shape of the energy absorbers will generally match a cross-sectional shape of the cavity in which it is placed, but that this is not required necessarily unless the functional aspects require that. The hood and energy absorber as a designed assembly are tuned to provide a force-deflection profile minimizing an HIC value. The energy absorber is preferably made of a polymeric material. When the energy absorber will be attached to the hood assembly prior to coating, the energy absorber will be made of a polymer capable of withstanding high temperatures associated with going through a paint over or e-coat process, such as high temperature nylon. However, it is contemplated that the material could also be metal or other structural material that absorbs energy during collapse. Also, one advantage of connecting the energy absorber to the hood but not sandwiching it between the hood layers is that it won't need to go through an oven.

A vehicle 120 (FIGS. 12 and 14) includes a front end 121 defining an engine compartment 122, and under-hood hard structural components therein, such as a fuse box, battery, shock tower, and an engine. The engine compartment 122 houses an engine 123, and a hood 124 generally covers the engine compartment 122. An engine cover 125 located under the hood 124 includes energy-absorbing features 126 (also called “crush lobes” herein) for absorbing energy from a top-down impact, such as when a pedestrian is struck and their head engages a top of the hood. The illustrated energy absorbing feature 126 comprises a hollow elongated crush lobe extending above a base flange/wall that generally coves a top of the engine. The illustrated part is injection molded of polymeric material, but it is contemplated that it could be made in different ways and be made from different materials. The crush lobes 126 each include a plurality of interconnected sidewalls extending from the base flange and a transverse top wall connecting the sidewalls. The base flange is located close to the engine, and the transverse top wall is located near the underside of the hood. By this arrangement, crush lobes are quickly engaged when a pedestrian's head strikes the hood so hard as to bend the hood inward toward the engine. As a result, the sidewalls of the crush lobe immediately begin to crumple and collapse with substantial and predictable energy-absorption. The cover 125 is designed for aesthetics and functionality to permit repair of the engine. As illustrated, it includes two upwardly-extending elongated energy-absorbing crush lobes (feature 126). The sidewalls of the illustrated feature 126 are relatively planar and extend generally vertically. However, it is contemplated that the crush lobes can be cone shaped or box shaped (or hexagonally shaped), and can include sidewalls incorporating corrugations or ribs or curvatures in order to achieve a desired energy absorption (i.e. force vs. deflection curve). Also, it is contemplated that more or less crush lobes can be used, and that their spacing and length can be adjusted for optimal energy absorption. As illustrated, two crush lobes are shown in FIG. 13, and three are shown in FIG. 13A. Specifically, the crush lobes 126 can be made longer or shorter and even non-linear to accommodate engine components and to accomplish energy absorption in specific areas of the engine. It is noted that the illustrated crush lobes extend vertically upwardly, but it is contemplated that if necessary they can be extended vertically downwardly. The illustrated crush lobes provide an energy-absorbing crush stroke of at least 20 mm. For example, the illustrated crush lobes are designed to provide a preferred resistance force to impact during a crush stroke of at least 10 mm, and a preferred resistance force to impact at a crush stroke of 30 mm, and provide a total crush stroke as desired depending of course on the space above a particular engine component being covered. Preferably, the crush lobe includes a plurality of interconnected sidewalls defining a polygonal shape and a transverse top wall connecting the sidewalls, since this shape has proven to provide a predictable crumpling collapse absorbing a substantial and significant amount of energy upon impact.

FIG. 14 illustrates an engine compartment 122 with the engine removed. FIG. 14 shows the hood inner panel, but the hood outer panel has been removed to show underlying engine components. The illustrated component cover 125 covers a top of the engine. It is noted that the cover 125 could be extended (or a separate cover provided) to cover a fuse box, or a battery, or the shock tower 129 immediately rearward of the battery.

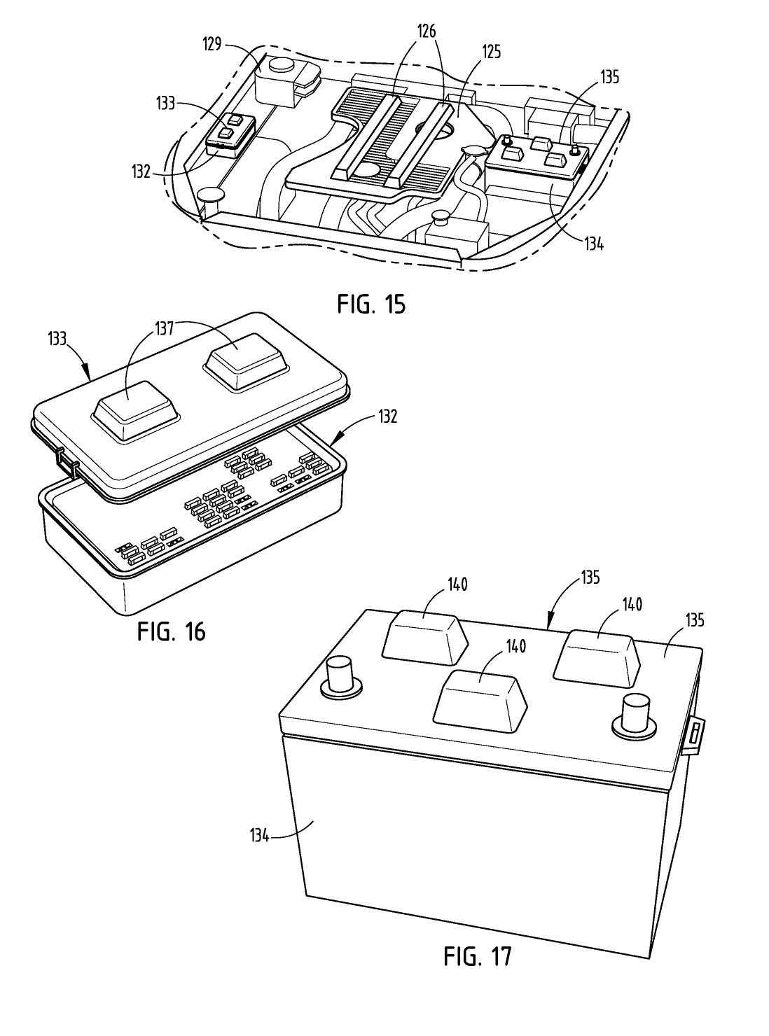

FIG. 15 is a perspective view of the engine compartment of FIG. 14, but with the hood fully removed. As shown, the engine compartment includes a fuse box 132 (see FIGS. 15 and 16), a fuse box cover 133, a battery 134, and a battery cover 135 (FIGS. 15 and 17). FIGS. 16 and 17 are perspective views of the fuse box cover 133 and battery cover 135 in FIG. 15. The fuse box cover 133 includes a panel body 136 shaped to aesthetically cover and protect the fuse box 132, and includes two upwardly extending crush lobes 137 positioned to interact with the hood (including hood inner and hood outer panels) during a pedestrian head impact against the hood, both to absorb energy to minimize injury to the pedestrian (such as to the pedestrian's head or hip), and also to minimize load spikes and “hot spots” on the underlying structure in the engine compartment, thus minimizing injury to the pedestrian from the impact. Notably, the crush lobes 137 are illustrated as extending upwardly and generally square, but it is contemplated that they could be different shapes, sizes, or configurations to accomplish their intended energy-absorbing task. Similarly, the battery cover 135 includes a panel body 139 shaped to aesthetically cover and protect the battery 134, and includes three upwardly extending crush lobes 140 positioned to interact with the hood (including hood inner and hood outer panels) during a pedestrian head impact against the hood, both to absorb energy to minimize injury to the pedestrian (such as to the pedestrian's head or hip), and also to minimize load spikes and “hot spots” on the underlying structure in the engine compartment to minimize injury to the pedestrian from the impact. Notably, the panel bodies (such as bodies 136 and 139) include apertures or hold-down flanges permitting attachment (such as by fasteners or frictional snap attachment) to underlying structure.

By this arrangement, improved energy absorption can be provided to reduce injury to a pedestrian's head, yet without adding parts and components. Further, existing components can be modified to include the raised energy absorbing feature, thus simplifying design of the modified component while also maintaining the function of the original component.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. In a vehicle including a front end having underhood hard structural components defining an engine compartment, an engine component, and a hood generally covering the engine compartment; an energy-absorbing improvement comprising:
a top cover under the hood and covering a part of at least one of the hard structural components and the engine component, the cover including at least one vertically-extending energy-absorbing feature configured specifically to absorb energy during a top-down impact from a pedestrian's head during a vehicle collision with the pedestrian, the feature being located under the hood and above the one component at a location to support the hood and cushion the impact against the head.

2. The improvement defined in claim 1, wherein the raised feature comprises a corrugated feature.

3. The improvement defined in claim 1, wherein the raised feature includes a crush lobe.

4. The improvement defined in claim 1, wherein the cover is made of polymeric material.

5. The improvement defined in claim 1, wherein the cover includes a panel body covering an enlarged area under the hood, and the raised feature extends upward from the panel body.

6. The improvement defined in claim 1, wherein the cover covers at least one of a fuse box, a battery, a shock tower, an engine block, an air cleaner, and a radiator.

7. The improvement defined in claim 6, wherein the cover including an attachment flange attaching the cover to at least one of the underhood hard structural components.

8. In a vehicle including a vehicle front end having underhood hard structural components defining an engine compartment, an engine component, and a hood generally covering the engine compartment; an energy-absorbing improvement comprising:
a top cover under the hood and covering a part of at least one of the hard structural components and the engine component, the cover including at least one vertically-extending energy-absorbing hollow crush lobe configured specifically to absorb energy during a top-down impact from a pedestrian's head during a vehicle collision with the pedestrian, the feature being located under the hood and above the one component at a location to support the hood and cushion the impact against the head.

9. The improvement defined in claim 8, wherein the at least one hollow crush lobe has an energy-absorbing force-versus-deflection curve minimizing injury to the pedestrian's head including an energy absorbing crush stroke of at least 20 mm.

10. The improvement defined in claim 8, wherein the at least one crush lobe provide a desired resistance force and energy absorption during impact of 10 mm stroke.

11. The improvement defined in claim 8, wherein the at least one crush lobe provide a resistance force and energy absorption during impact of 30 mm stroke.

12. The improvement defined in claim 8, wherein the at least one crush lobe includes a plurality of interconnected sidewalls defining a polygonal shape.

13. The improvement defined in claim 8, wherein the energy absorber is a unitary molded polymeric part.

14. A combination including a vehicle front end having underhood hard structural components defining an engine compartment, an engine component, and a hood assembly generally covering the engine compartment, the hood assembly including a hood outer panel and a hood inner panel; an improvement comprising:
an energy absorber positioned between the hood outer panel and a selected one of the underhood hard structural components, the energy absorber including a base flange and a plurality of hollow crush lobes extending from the base flange in a direction generally perpendicular to an adjacent portion of the hood outer panel.

15. A method comprising:
providing a vehicle front end having underhood hard structural components defining an engine compartment, an engine component, and a hood assembly generally covering the engine compartment, the hood assembly including a hood outer panel and a hood inner panel;
providing an energy absorber including a base flange and a plurality of hollow crush lobes extending from the base flange;
positioning the energy absorber between the hood outer panel and a selected one of the underhood hard structural components with the crush lobe of the energy absorber extending in a direction generally perpendicular and upwardly relative to an adjacent portion of the hood outer panel.
